(19) United States
(12) Patent Application Publication
(10) Pub. No.: US 2008/0024022 A1
(43) Pub. Date: Jan. 31, 2008

(54) Motor wiring seat for a motor

(76) Inventor: Chun-Pin Wu, Taichung (TW)

Correspondence Address: Chun-Pin Wu, 235 Chung-Ho, Box 8-24, Taipei, omitted

(21) Appl. No.: 11/492,658

(22) Filed: Jul. 26, 2006

(51) Int. Cl. H02K 37/14; H02K 11/00

(52) U.S. Cl. 310/71; 310/49 R; 310/194

(57) ABSTRACT

A motor wiring seat for a motor comprises a driving assembly; and a coil seat including: a wiring shaft; a periphery of the wiring shaft forming a first combining portion; and a wiring seat separated from the wiring shaft; the wiring seat having a second combining portion combinable to the first combining portion; so that the wiring seat being combined to the wiring shaft. The first combining portion is a dovetail seat, and the second combining portion is a dovetail recess. The motor is a step motor. The motor has a casing.

### FIELD OF THE INVENTION

The present invention relates to motor components, and in particular to a motor wiring seat for a motor, wherein the wiring seat is separated from the wiring shaft so as to avoid the interference of the wiring seat to the wiring shaft in winding the wires of coil of the motor.

### BACKGROUND OF THE INVENTION

In a motor, current is transferred to a coil for generating magnetic field so as to rotate a magnetic rotor. The rotation speed, angle and strength of the rotor can be controlled by changing the strength and pulse of the current. Other than coil, core, and rotor, a motor further has a wiring seat for inputting current. Thus wiring seat is an important device.

In one prior art, the motor is a long wiring shaft which are wound with conductive wires at two ends thereof. A center of the wiring shaft is formed with the wiring seat for inputting current so as to conduct the coils.

The wiring seat has conductive posts for conducting current. Thereby the wiring seat has a sufficient area for installing the conductive posts. Since the wiring seat is at a center portion of the wiring shaft, the area of the wiring seat will interfere the winding of the coils so that it is difficult to wind the coils. Thus, the yield ratio is low. Moreover the portion of the coil shielded by the winding seat will induce some problem in use.

### SUMMARY OF THE INVENTION

Accordingly, the primary object of the present invention is to provide a motor wiring seat for a motor, wherein the wiring seat is separated from the wiring shaft so as to avoid the interference of the wiring seat to the wiring shaft in winding the wires of coil of the motor.

To achieve above objects, the present invention provides a motor wiring seat for a motor which comprises a driving assembly; and a coil seat including: a wiring shaft; a periphery of the wiring shaft forming a first combining portion; and a wiring seat separated from the wiring shaft; the wiring seat having a second combining portion combinable to the first combining portion; so that the wiring seat being combined to the wiring shaft. The first combining portion is a dovetail seat, and the second combining portion is a dovetail recess. The motor is a step motor. The motor has a casing.

The various objects and advantages of the present invention will be more readily understood from the following detailed description when read in conjunction with the appended drawing.

### BRIEF DESCRIPTION OF THE DRAWINGS

FIGS. 1 and 2 are assembled schematic view of the motor wiring seat for a motor of the present invention.

FIG. 3 is an exploded perspective view of the motor wiring seat for a motor of the present invention.

FIG. 4 is a schematic perspective view of the motor wiring seat for a motor of the present invention.

FIG. 5 is a perspective view of the motor wiring seat for a motor of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

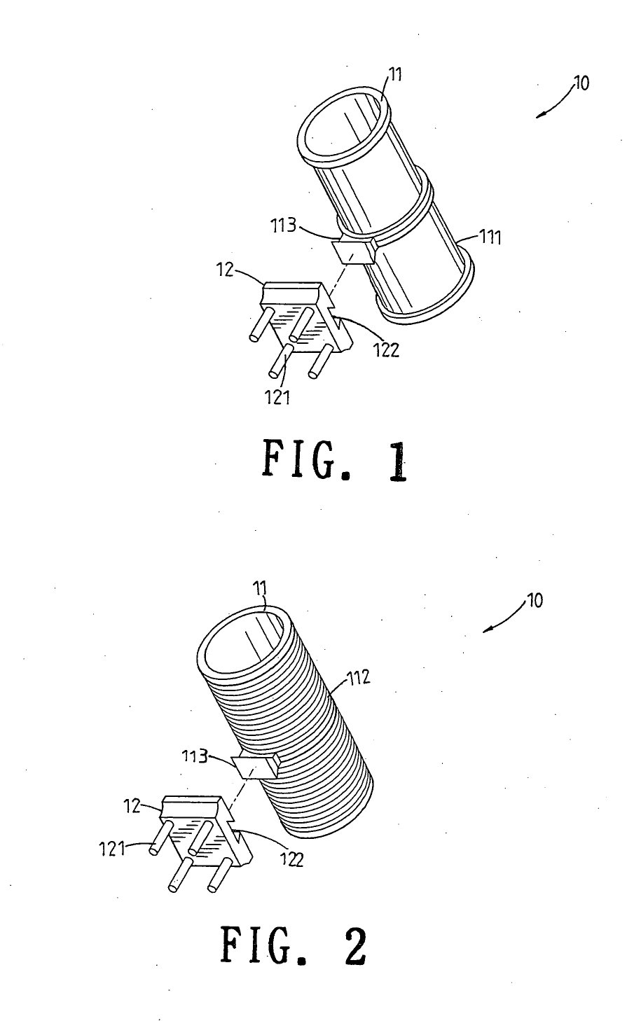

Referring to FIGS. 1 to 3, the motor with a motor wiring assembly of the present invention is illustrated. The present invention has a motor body 1 which has the following elements.

A coil seat 10 includes a wiring shaft 11 and a wiring seat 12. The wiring shaft 11 has a rod shape which is formed with two winding areas 111 at two sides thereof for winding wires. A center portion of the outer surface of the wiring shaft 11 is formed with a first combining portion 113 having a dovetail shape.

A wiring seat 12 is assembled to the first combining portion 113 of the coil assembly 10. The wiring seat 12 has a plate shape. One side of the wiring seat 12 is protruded with a plurality of conductive posts 121 for conducting current. Another side of the wiring seat 12 is formed with a second combining portion 122. The second protrusion 12 is formed as a dovetail recess so as to be buckled with the first combining portion 113. Thereby current flows from the conductive posts 121 to the coils 112 wound around the wiring shaft 11.

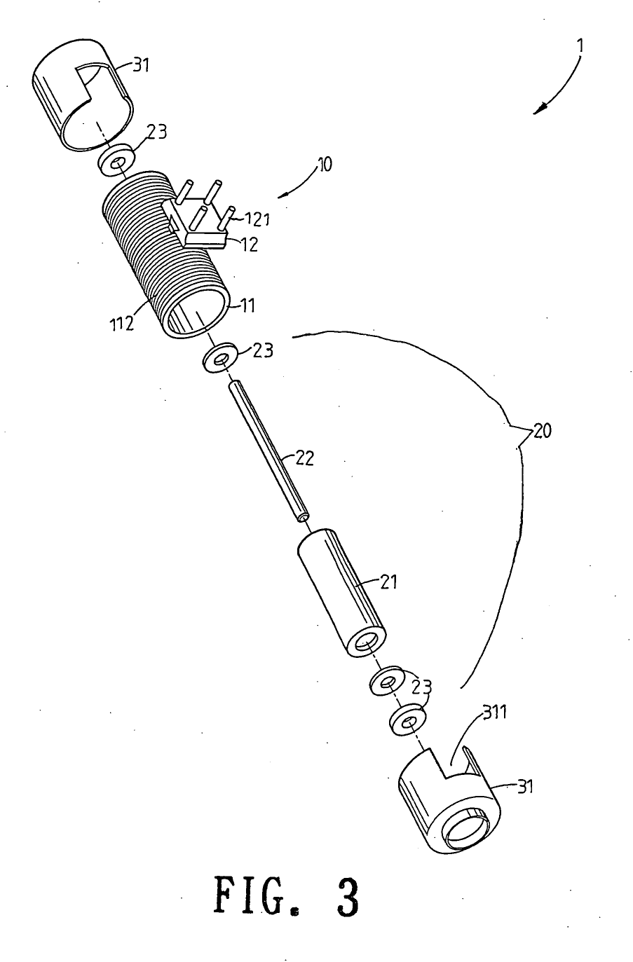

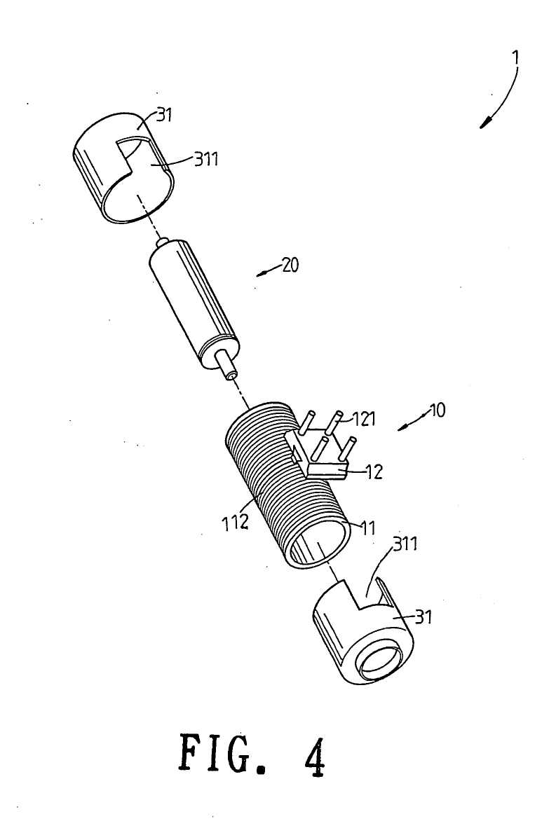

Referring to FIGS. 3 to 4, the driving assembly 20 includes a motor body 1 and a rotary shaft 22. The driving assembly 20 is confined by the coil seat 10 by using a plurality of rings 23 located at two ends of the driving assembly 20. The rotation speed of the driving assembly 20 is controlled by the coils 112 of the coil seat 10 so as to increase the operation of the motor body 1. The structure and operation of the driving assembly 20 is known in the portion and thus the detail will not be described herein.

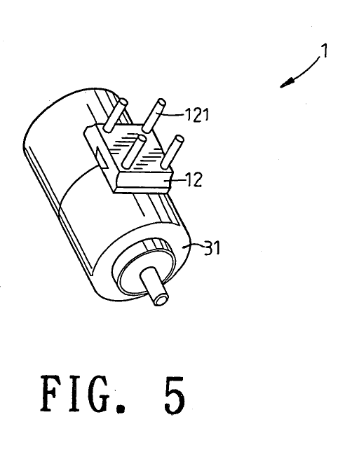

Referring to FIGS. 3 to 5, the present invention further includes two covers 31 at two ends. Each cover 31 is a round cylinder shaped corresponding to that of the wiring shaft 11 of the coil seat 10. Each cover 31 is formed with an opening 311 for protruding the wiring shaft 11. The two covers 31 serve to enclose and protect the coils 112 of the wiring shaft 11. After assembly, the conductive posts 121 protrude out from the openings 311 of the covers 31 so as to assemble the motor body 1.

In the present invention, the wiring shaft 11 of the coil seat 10 is separated from the wiring seat 12. Before assembly, the coil 112 is wound around the winding area 111, as shown in FIG. 2. Then, the wiring seat 12 is assembled to the wiring shaft 11. Thus the winding the coil 112 will not be interfered by the wiring seat 12 so as to increase the yield ratio and quality.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A motor wiring seat for a motor, comprising;
a wiring shaft; a periphery of the wiring shaft forming a first combining portion; and
a wiring seat separated from the wiring shaft; the wiring seat having a second combining portion combinable to the first combining portion; so that the wiring seat being combined to the wiring shaft.

2. A motor wiring seat for a motor, comprising:
a driving assembly; and
a coil seat including:
a wiring shaft; a periphery of the wiring shaft forming a first combining portion; and
a wiring seat separated from the wiring shaft; the wiring seat having a second combining portion combinable to the first combining portion; so that the wiring seat being combined to the wiring shaft.

3. The motor wiring seat for a motor as claimed in claim 1, wherein the first combining portion is a dovetail seat, and the second combining portion is a dovetail recess.

4. The motor wiring seat for a motor as claimed in claim 1, wherein the motor is a step motor.

5. The motor wiring seat for a motor as claimed in claim 1, wherein the motor has a casing.
